(19) United States
(12) Patent Application Publication
(10) Pub. No.: US 2023/0196838 A1
(43) Pub. Date: Jun. 22, 2023

(54) VIDEO RECOGNITION METHOD AND APPARATUS, AND STORAGE MEDIUM

(71) Applicant: Beijing Wodong Tianjun Information Technology Co., Ltd., Beijing (CN)

(72) Inventors: Zeyu LEI, Beijing (CN); Junzhou MOU, Beijing (CN); Jingjing LYU, Beijing (CN); Zheng ZHANG, Beijing (CN)

(21) Appl. No.: 18/065,176

(22) Filed: Dec. 13, 2022

(30) Foreign Application Priority Data
Dec. 17, 2021 (CN) 202111562144.2

(51) Int. Cl. G06V 40/20; G06T 3/40; G06T 5/50; G06V 10/771; G06V 10/77; G06V 10/44

(52) U.S. Cl. CPC G06V 40/20; G06T 3/40; G06T 5/50; G06V 10/771; G06V 10/7715; G06V 10/454; G06T 2207/20132; G06T 2207/20221; G06T 2207/30196

(57) ABSTRACT

A video recognition method and apparatus and storage medium are disclosed. In the method, n first eigenvectors corresponding to each of m first image frames of a first video is determined; the first eigenvector represents a spatial eigenvector of the corresponding first image frame; a second eigenvector is extracted from the first eigenvectors, and the second eigenvector is processed through a fully connected layer to obtain a third eigenvector; the second eigenvector represents a time sequence eigenvector corresponding to the m first image frames; a first behavior type between first and second object corresponding to the first video is determined based on the third eigenvector; each element in the third eigenvector represents probability of a behavior type; and when the first behavior type is a set behavior type, a video recognition result of the first video is determined based on the first behavior type and type of the second object.

### CROSS-REFERENCE TO RELATED APPLICATION

This application is based upon and claims priority to Chinese Patent Application No. 202111562144.2, filed on Dec. 17, 2021 and entitled “VIDEO RECOGNITION METHOD AND APPARATUS, ELECTRONIC DEVICE, AND STORAGE MEDIUM”, the disclosure of which is hereby incorporated by reference in its entirety.

### BACKGROUND

With the popularity of video advertisements, video advertisements that take people as a subject may show the interaction between people and commodities to obtain a better commodity display effect. At present, in order to recognize interactive behaviors between people and the commodities in videos, a large number of annotated samples are required, and the cost of acquiring model training samples is relatively high.

### SUMMARY

In view of this, embodiments of the present disclosure provide a video recognition method and apparatus, an electronic device, and a storage medium.

The technical solutions of the embodiments of the present disclosure are implemented as follows.

The embodiments of the present disclosure provide a video recognition method, which may include the following operations. N first eigenvectors corresponding to each of m first image frames of a first video are determined. The first eigenvector represents a spatial eigenvector of the corresponding first image frame. The image content of the first image frame may include a first object and a second object. A second eigenvector is extracted from the first eigenvectors corresponding to the m first image frames, and the second eigenvector is processed through a fully connected layer to obtain a third eigenvector. The second eigenvector represents a time sequence eigenvector corresponding to the m first image frames. A first behavior type between the first object and the second object corresponding to the first video is determined based on the third eigenvector. Each element in the third eigenvector correspondingly represents the probability of a behavior type. In a case where the first behavior type is a set behavior type, a video recognition result of the first video is determined based on the first behavior type and the type of the second object. Herein, m and n are both positive integers.

The embodiments of the present disclosure further provide a video recognition apparatus, which may include: a memory for storing executable instructions; and a processor, wherein the processor is configured to execute the instructions to perform operations of: determining n first eigenvectors corresponding to each of m first image frames of a first video, the first eigenvector representing a spatial eigenvector of a corresponding first image frame, and image content of the first image frame comprising a first object and a second object; extracting a second eigenvector from the first eigenvectors corresponding to the m first image frames, and processing the second eigenvector through a fully connected layer to obtain a third eigenvector, the second eigenvector representing a time sequence eigenvector corresponding to the m first image frames; determining a first behavior type between the first object and the second object corresponding to the first video based on the third eigenvector, each element in the third eigenvector correspondingly representing a probability of a behavior type; and in a case where the first behavior type is a set behavior type, determining a video recognition result of the first video based on the first behavior type and a type of the second object; wherein m and n are both positive integers.

The embodiments of the present disclosure further provide a storage medium, on which a computer program is stored. The computer program implements, when executed by a processor, a above video recognition method, the method including: determining n first eigenvectors corresponding to each of m first image frames of a first video, the first eigenvector representing a spatial eigenvector of a corresponding first image frame, and image content of the first image frame comprising a first object and a second object; extracting a second eigenvector from the first eigenvectors corresponding to the m first image frames, and processing the second eigenvector through a fully connected layer to obtain a third eigenvector, the second eigenvector representing a time sequence eigenvector corresponding to the m first image frames; determining a first behavior type between the first object and the second object corresponding to the first video based on the third eigenvector, each element in the third eigenvector correspondingly representing a probability of a behavior type; and in a case where the first behavior type is a set behavior type, determining a video recognition result of the first video based on the first behavior type and a type of the second object; wherein m and n are both positive integers

### BRIEF DESCRIPTION OF THE DRAWINGS

FIG. 1 is an implementation flowchart of a video recognition method according to an embodiment of the present disclosure.

FIG. 2 is an implementation flowchart of a video recognition method according to an application embodiment of the present disclosure.

FIG. 3 is a schematic diagram of a detection process according to an application embodiment of the present disclosure.

FIG. 4 is a schematic diagram of eigenvector embedding according to an application embodiment of the present disclosure.

FIG. 5 is a schematic structural diagram of a video recognition apparatus according to an embodiment of the present disclosure.

FIG. 6 is a schematic structural diagram of an electronic device according to an embodiment of the present disclosure.

### DETAILED DESCRIPTION

With the popularity of video advertisements, the video advertisements have gradually replaced print advertisements and have become a new generation of mainstream commodity advertisement form. Video advertisements taking people as a subject may show the interaction between people and commodities to obtain a better commodity display effect. In the video advertisements, there are many interactive behaviors between people and the commodities. Through recognizing such interactive behaviors, accurate recommendation of the commodities may be achieved and the quality of the video advertisements is improved.

At present, in order to recognize the interactive behaviors between people and the commodities in the video, for each behavior type, a combination with various commodity types must be prepared as a model training sample. That is, a large amount of combinations of the behavior types and the commodity types are required as annotation samples, and the cost of acquiring the model training sample is relatively high.

In view of the above, in various embodiments of the present disclosure, n first eigenvectors corresponding to each of m first image frames of a first video are determined. The first eigenvector represents a spatial eigenvector of the corresponding first image frame. The image content of the first image frame may include a first object and a second object. A second eigenvector is extracted from the first eigenvectors corresponding to the m first image frames, and the second eigenvector is processed through a fully connected layer to obtain a third eigenvector. The second eigenvector represents a time sequence eigenvector corresponding to the m first image frames. A first behavior type between the first object and the second object corresponding to the first video is determined based on the third eigenvector. Each element in the third eigenvector correspondingly represents the probability of a behavior type. In a case where the first behavior type is a set behavior type, a video recognition result of the first video is determined based on the first behavior type and the type of the second object. Herein, m and n are both positive integers. In the above solution, the video recognition result is determined by respectively detecting the behavior type and object type of the video. In this way, the sample does not need to be annotated through a combination of the behavior type and the object type, which reduces the number of samples required for video recognition and reduces the cost of acquiring a video recognition model.

In order to make the purposes, technical solutions and advantages of the present disclosure clearer, the present disclosure will be further described below in detail in conjunction with the accompanying drawings and embodiments. It is to be understood that that the specific embodiments described herein are only used to illustrate the present disclosure, but are not intended to limit the present disclosure.

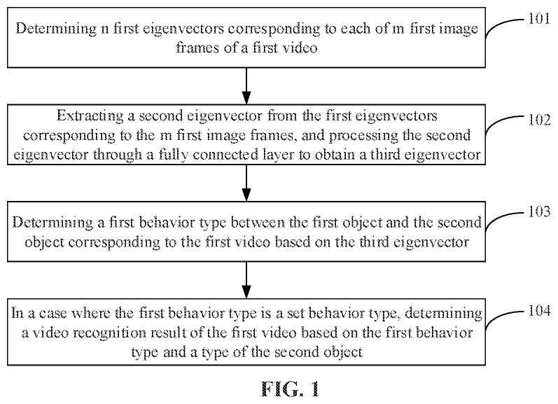

FIG. 1 is an implementation flowchart of a video recognition method according to an embodiment of the present disclosure. The embodiments of the present disclosure provide a video recognition method, which is applied to an electronic device. Herein, the electronic device includes, but is not limited to, electronic devices such as a server and a terminal. The method includes the following operations.

At S101, n first eigenvectors corresponding to each of m first image frames of a first video are determined.

Herein, the first eigenvector represents a spatial eigenvector of the corresponding first image frame. The image content of the first image frame includes a first object and a second object. Herein, m and n are both positive integers.

The m first image frames are determined from the first video, and feature extraction is performed on each first image frame to obtain corresponding n first eigenvectors. Here, when the corresponding first eigenvector is determined based on the first image frame, different image frame feature extraction methods may be adopted, and include, but are not limited to, that; spatial feature extraction is performed on each first image frame to obtain a corresponding feature map, then the corresponding feature map is processed by a convolution kernel of the set size, and the first eigenvector is obtained based on the processed feature map; and the first image frame is segmented into a set number of image blocks, and feature extraction is performed on the image blocks to obtain the first eigenvector.

In an embodiment, the first object represents a set part of a person. The second object represents an item.

Herein, the image content of each first image frame includes the set part of the person and the item, and the set part of the person may be a face, a human hand, a limb and/or a torso, etc. The first behavior type between the first object and the second object may be a behavior between the set part of the person and the item, for example, an interactive behavior between the set part of the person and the item. The item included in the image content of the image frame may be a commodity.

At S102, a second eigenvector is extracted from the first eigenvectors corresponding to the m first image frames, and the second eigenvector is processed through a fully connected layer to obtain a third eigenvector.

Herein, the second eigenvector represents a time sequence eigenvector corresponding to the m first image frames. Each element in the third eigenvector correspondingly represents the probability of a behavior type.

Feature extraction is performed on the first eigenvectors corresponding to the m first image frames to obtain the second eigenvector, the second eigenvector is processed through the set fully connected layer, and the elements of the output eigenvector are processed by a Softmax function to obtain the third eigenvector of the set dimension. Each element in the third eigenvector correspondingly represents the probability that the behavior of the first video is a certain behavior type.

At S103, a first behavior type between the first object and the second object corresponding to the first video is determined based on the third eigenvector.

The behavior type corresponding to the at least one element is determined as the first behavior type between the first object and the second object corresponding to the first video based on the elements of the third eigenvector. Here, the basis for determining the first behavior type includes, but is not limited to, that: the behavior type corresponding to one or more largest elements in the elements of the third eigenvector is taken; and the behavior type corresponding to one or more elements greater than a set threshold in the elements of the third eigenvector is taken.

At S104, in a case where the first behavior type is a set behavior type, a video recognition result of the first video is determined based on the first behavior type and the type of the second object.

The at least one behavior type is set as the set behavior type, whether the first behavior type is the set behavior type is determined, and how to determine the video recognition result of the first video is determined according to a determining result. In a case where the first behavior type is the set behavior type, the video recognition result of the first video is determined based on the first behavior type and the recognized type of the second object of the first video.

Here, a detection network based on Yolov5 may be used to recognize the type of the second object on the at least one first image frame of the first video, recognize the type of the second object corresponding to each first image frame, and weight a type recognition result of each image frame in the at least one image frame to determine the type of the second object of the first video. Herein, the detection network may be set as required, and in a case where the second object represents the item, the object type recognition may recognize a category name to which the item belongs.

In practical application, an e-commerce scenario is used as an example for illustration. In this e-commerce scenario, the item represented by the second object is a commodity. Here, some or all of the behavior types are determined as behavior types taking the commodity (the second object) as the subject. These behavior types are set behavior types. The remaining behavior types are behavior types taking a non-commodity (the first object) as the subject, and the behavior types taking the non-commodity as the subject are people usually. In a case where the determined first behavior type is the set behavior type, the video recognition result of the first video is determined based on the first behavior type and the recognized commodity type of the second object.

In the embodiment of the present disclosure, the video recognition result is determined by respectively detecting the behavior type and the object type of the video. In this way, the sample does not need to be annotated through a combination of the behavior type and the object type, which reduces the number of samples required for video recognition and reduces the cost of acquiring the video recognition model.

Meanwhile, different video recognition result determining strategies are executed according to whether the first behavior type is the set behavior type. Whether the behavior type is the set behavior type is determined, and the type of the second object in the first video is recognized through the detection network for the set behavior type. In this way, the interaction (behavior and object) type in the video is determined based on the behavior type between the first object and the second object in the first video and the type of the second object, thereby determining the video recognition result more accurately.

Herein, in an embodiment, the method further includes the following operations.

In a case where the first behavior type is not the set behavior type, the video recognition result of the first video is determined based on the first behavior type.

In a case where the first behavior type is not the set behavior type, the first behavior type is used as the video recognition result.

As mentioned above, the e-commerce scenario is used as an example for illustration, some or all of the behavior types are determined as the behavior types taking the commodity (the second object) as the subject. These behavior types are the set behavior types. The remaining behavior types are the behavior types taking the non-commodity (the first object) as the subject. Here, in a case where the determined first behavior type is not the set behavior type, that is, the behavior type taking the non-commodity as the subject, the video recognition result of the first video is determined based on the first behavior type.

A multi-strategy method is set, and the set behavior type is used as a branch determining condition to execute different video recognition result determining strategies. In practical application, the set behavior type is set, for the behavior types taking the second object as the subject, the object type is recognized through the detection network, and the video recognition result is accurately determined based on the behavior type and the object type between the first object and the second object in the first video. For the behavior types taking the first object as the subject, the behavior type in the first video is used as the video recognition result. In this way, whether the object type is used as the video recognition result is determined by the behavior type. For the behavior types taking the second object (item) as the subject, usually these behavior types have a relatively high degree of interaction with the second object, such as cut an apple, raise a glass, etc., the video recognition result is further determined in combination with the object type, thereby improving the recognition accuracy of the video recognition result.

Preferably, in the e-commerce scenario, the behavior types taking the commodity as the subject, usually these behavior types have a relatively high degree of interaction with the commodity, and the video recognition result is determined in combination with the commodity type, so that the recognition accuracy of a video advertisement recognition result is improved. Accurate recommendation may be achieved based on the recognition result, so that the quality of video advertisements is improved.

In an embodiment, the operation that n first eigenvectors corresponding to each of m first image frames of the first video are determined may include the following operations.

Each of the m first image frames is input into a first feature extraction model to obtain a first feature map of each first image frame output by the first feature extraction model.

N second feature maps corresponding to the first feature map of each first image frame are obtained through a convolution kernel of the set size.

Feature extraction is performed on each of the n second feature maps corresponding to each first feature map to obtain n first eigenvectors corresponding to each first image frame.

Feature extraction is performed on each of the m first image frames through the first feature extraction model to obtain the first feature map corresponding to each first image frame, then channel features are compressed through convolution of a convolution kernel of the set size (for example, 1*1 convolution kernel) to obtain the n second feature maps, and the corresponding first eigenvector is obtained based on each of the n second feature maps, so as to obtain the n first eigenvectors corresponding to each first image frame.

Here, the first feature extraction model may be a set ResNet model. Preferably, the first feature extraction model is ResNet50 pre-trained on imagenet.

In the embodiment of the present disclosure, for the first feature map obtained by performing feature extraction on each first image frame, the second feature map is obtained by compressing the channel features through the convolution kernel of the set size, and the first eigenvector is obtained based on the second feature map. In this way, the feature information of an image is extracted without splitting the spatial features of the image, and the first eigenvector is used as the input of ae recognition network, which may improve the accuracy of the behavior type recognition of the network.

In an embodiment, the operation that each of the m first image frames is input into the first feature extraction model may include the following operations.

Each of the m first image frames of the first video is scaled according to a set ratio, and cropped through a crop box of the set size to obtain m processed first image frames.

Each of the processed m first image frames is input into the first feature extraction model.

Due to the wide range of video sources and the differences in the aspect ratio, resolution and other specifications of the videos, the m first image frames of the first video may be processed, and the processed first image frames are of the set size. Here, the first image frame is first scaled according to the set ratio, then the scaled image is cropped through the crop box of the set size, and the cropped image is used as the input of the first feature extraction model.

In practical application, when the set ratio is determined, any value in (256, 320) may be randomly determined as the length of the short side of the scaled image through bilinear/bicubic sampling, and the determined scaling ratio is used as the set ratio.

After the video image is scaled according to the set ratio, the first image frame is obtained by cropping through the crop box of the set size, so that the size of the cropped first image frame is within the optimal range of the effect of the first feature extraction model. The optimal range of the effect here is determined according to the size of the sample for training the first feature extraction model. In this way, the extracted eigenvector may better represent the image content, thereby improving the accuracy of the behavior type recognition of the network.

In an embodiment, the operation that the second eigenvector is extracted from the first eigenvectors corresponding to the m first image frames may include the following operations.

The first eigenvectors corresponding to the m first image frames are input into a second feature extraction model to obtain the second eigenvector output by the second feature extraction model. The second feature extraction model is configured to extract time sequence feature from the input first eigenvectors to obtain the corresponding second eigenvector.

Here, the second eigenvector may be obtained by extracting the first eigenvectors corresponding to the m first image frames using the second feature extraction model.

Herein, the second feature extraction model may be a set Transformer model. The set Transformer model is an attention mechanism. Compared with the problems such as gradient disappearance and the like when a Long Short-Term Memory (LSTM) model processes long-distance sequences in the related art, the Transformer model of the attention mechanism is more closely related to the input eigenvector, and the effect in processing long-distance sequences is better. The second eigenvector extracted based on the set Transformer model may improve the accuracy of determining the first behavior type.

In an embodiment, the second feature extraction model includes at least two hidden layer combinations connected in series. Each hidden layer combination includes a first hidden layer and a second hidden layer connected in series. The first hidden layer is configured to extract spatial features of each first image frame based on the input eigenvector. The second hidden layer is configured to output time sequence features among the m first image frames based on the spatial features of respective input first image frames.

Here, the second feature extraction model includes the at least two hidden layer combinations connected in series. Each hidden layer combination includes the first hidden layer and the second hidden layer connected in series. The first hidden layer is configured to extract the spatial features of each first image frame based on the n eigenvectors corresponding to each input first image frame. The second hidden layer is configured to output the time sequence features among the m first image frames based on the spatial features of respective input first image frames.

After the first eigenvectors corresponding to the m first image frames are input into the first hidden layer of the first hidden layer combination of the second feature extraction model, the n first eigenvectors corresponding to each first image frame is first processed by the first hidden layer of the first hidden layer combination, and the spatial features of each first image frame are extracted. Then, the spatial features of each of the m first image frames are processed by the second hidden layer of the first hidden layer combination, the time sequence features among the m first image frames are extracted, and the determined eigenvector is input into the first hidden layer of the next hidden layer combination (the second hidden layer combination). The above process is repeated until a set termination condition is met, and the time sequence features among the m first image frames are output.

Compared with the single hidden layer processing, each hidden layer combination of the second feature extraction model is set to two layers, which are configured to extract the spatial features of each image frame and extract the time series features between the m image frames respectively. In this way, the spatial features and the time series features are respectively extracted through two hidden layers, so that the separation of the spatial features and the time series features in feature extraction is realized, and the hidden layer requires fewer parameters and lower training cost.

In an embodiment, before the first eigenvectors corresponding to the m first image frames are input into the second feature extraction model, the method further includes the following operations.

In a case where the behavior type of a sample is the set behavior type, the type of the second object in a corresponding annotation is deleted to obtain a processed sample.

The second feature extraction model is trained based on the processed sample.

Before using the second feature extraction model, the second feature extraction model is trained. By preprocessing data samples of a Kinetics700 dataset or other datasets, the annotation of the behavior type of the data taking the first object as the subject remains unchanged, and the annotation of the behavior type taking the second object as the subject removes a name of the specific object type, and only retains an action verb as the annotation of the data.

Here, when the data samples of the dataset are preprocessed, the same video processing method as the second feature extraction model in the using process is adopted.

Based on a processed sample training model, a model output result obtained by training may be configured to determine whether the subject corresponding to the behavior type is the second object. In this way, the model output result may be used as a condition for whether to further combine the object type of the recognized second object. In a case where the model output result represents that the first behavior type is the set behavior type, the video recognition result of the first video is determined by combining the first behavior type and the object type of the second object.

In practical application, the e-commerce scenario is still used as an example to illustration. When the annotations of the data in the dataset are processed, it is necessary to determine whether the subject corresponding to the behavior type is the commodity (the second object). Here, a taker of the behavior type may be used as the basis for classifying whether the subject corresponding to the behavior type is the commodity. In other words, whether the object of the behavior type (verb) is the commodity may be used as the basis of determination. For example, if the annotation of the sample is “blow hair”, and hair is a non-commodity, the annotation of the behavior type of the data remains unchanged and is still “blow hair”. For another example, if the annotation of the sample is “cut an apple”, and the apple is a commodity, the specific commodity name “apple” is removed from the annotation of the behavior type of the data, and only retains the verb “cut” of the behavior type as the annotation of the data. Then, in a case where the first behavior type determined by the second eigenvector output by the second feature extraction model is a single verb (for example. “cut”), the corresponding first video takes the commodity as the subject. In a case where the first behavior type determined by the second eigenvector output by the second feature extraction model is a verb and an object (for example, “blow hair”), the corresponding first video takes the non-commodity as the subject. In this way, the video recognition result of the first video may further be determined by combining the recognized behavior type.

In an embodiment, before the n first eigenvectors corresponding to each of the m first image frames of the first video are determined, the method further includes the following operations.

Multiple second image frames of the second video are input into a recognition model to obtain an image recognition result output by the recognition model.

At least two second image frames whose corresponding image recognition results meet a set splicing condition are spliced to obtain the first video.

The recognition model is configured to recognize the first object in the input second image frame, and output the corresponding image recognition result. The image recognition result represents the confidence that the first object is contained in the corresponding second image frame.

The video sources are wide, taking a video obtained from live screen recording as an example, due to the movement of an anchor, the image content of some video clips does not include people, and the set part of the person (the first object) is also not included. If the image frames not including the video clips of the first object are used, the accuracy of the video recognition may be affected.

In the embodiment of the present disclosure, the first object is recognized on the image frame of the video through the recognition model, and at least two second image frames whose corresponding recognition results meet a set splicing condition are sorted in chronological order, and are spliced in order to obtain the first video. Herein, the set splicing condition is set according to the type of the image output result, which includes, but is not limited to, that: when the image recognition result is a binary classification result, it is determined that the second image frame includes the first object; and in a case where the image recognition result is the confidence, it is determined that the confidence of the first object included in the second image frame is greater than the set threshold.

Here, the recognition model may be a set MTCNN model. Preferably, the recognition model is obtained by training a large dataset of the set part of the person, such as a Winderface dataset.

In this way, the first video is obtained by screening the at least two second image frames meeting the set splicing condition in the second video, and it is ensured that each first image frame in the first video includes the first object, thereby improving the accuracy of video recognition.

The present disclosure will be further described below in detail in conjunction with application examples.

Recognition of the interactive behaviors between people and the commodities in the videos in the e-commerce scenario has the following problems.

1) In the e-commerce scenario, there are many types of commodities displayed through the videos. A behavior recognition dataset for the e-commerce scenario is established using manual annotation. Due to too many commodity types, the annotation cost of the samples is huge. However, the existing behavior recognition datasets are classified according to actions. Even if different objects interact with people, they may also be classified into the same category.

2) In the e-commerce scenario, the video content is complex, and there are video clips which are not related to interaction recognition, such as brand promotion and special effects of the commodity. When frame extraction is performed on the video at equal intervals, the sampling of the obtained video clips may affect the accuracy of commodity recognition.

3) When video recognition is performed, each image frame needs to be segmented into multiple patch blocks. Each patch quickly represents a small image area obtained by segmenting the image, and each patch block corresponds to one eigenvector. The video recognition performed based on this eigenvector may split the spatial features of the image itself. The Patch block refers to a small image area obtained by image segmentation. For example, an image of 256*256 may be segmented into 16 patch blocks of 16*16.

Based on this, the application embodiment provides a video recognition solution based on temporal and spatial features, which improves the accuracy of video recognition and richness of interaction recognition species by segmenting the video clips and detecting the commodity types through face and/or body recognition. The solution is specifically as follows.

1) For the problem of many types of commodities in the e-commerce scenario, but few types of behavior recognition datasets, the richness of interaction (behavior or object) types in video recognition is improved using a behavior recognition and commodity detection solution. In addition, the sample annotations in the behavior recognition dataset are preprocessed. For the sample taking the commodity as the subject (that is, a behavior taker is the commodity), the nouns in the sample annotation are removed and the behavioral verbs are retained. For the sample taking the non-commodity as the subject (that is, the behavior taker is not the commodity, such as hair of a person), the sample annotation is not processed. In this way, during recognition, the video taking the commodity as the subject returns the action verbs, and further combines the nouns of the commodity type recognition result to obtain the video recognition result (for example: cut a cake or cut fruit). The video taking the non-commodity as the subject returns the action verbs as video recognition result (for example: blow hair).

2) For the problem of complex video content in the e-commerce scenario, face and/or body recognition is adopted for the video, the clips containing faces and/or human bodies are extracted from the video, and frame extraction is performed on the extracted video clips for interactive recognition.

3) For the problem that the image frame is segmented into multiple patch blocks may destroy the spatial features, a convolutional neural network is used to extract the features, and the multi-channel features (feature maps) are vectorized as the input of the behavior type recognition network.

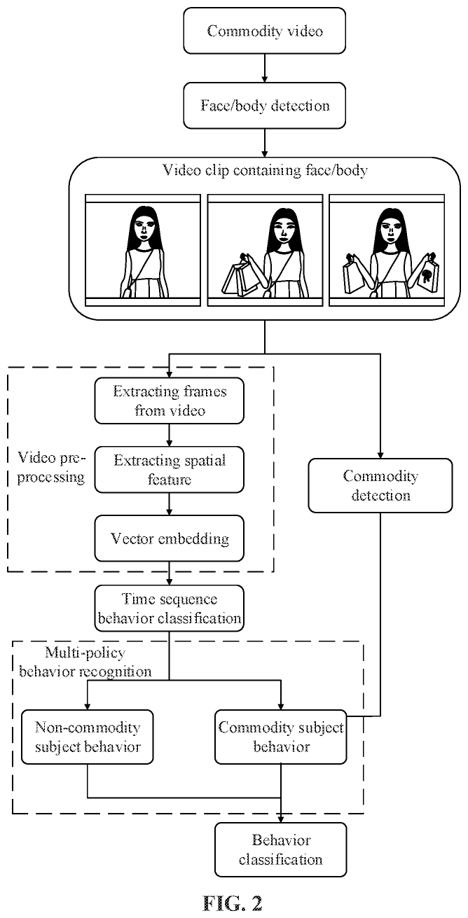

FIG. 2 shows an implementation flowchart of a video recognition method according to an application embodiment of the present disclosure, which at least includes the following operations.

1) Face/body detection.

The purpose of face and/or human detection is to obtain video clips with human participation, the video clips are highly related to a video recognition task, and irrelevant video clips may affect the accuracy of video recognition detection. Here, face recognition is used as an example for illustration. In practical application, it may be face recognition, body recognition, or a combination of face recognition and body recognition. The specific process is as follows.

Firstly, the input video is the commodity video of the video advertisement, which includes, but is not limited to: a commodity main video and a recommended video. There is no limitation on the size and frame rate of the input video. The aspect ratio of the input video is r, and the duration t of the input video does not exceed 2 minutes. If the duration of the video exceeds 2 minutes, the video may be segmented into multiple video clips not exceeding 2 minutes, and each video clip is detected.

Secondly, in order to improve the speed of face detection, frame extraction and scaling are performed on the input video. In practical application, 2*t image frames are obtained using the sampling frequency of 2 frames per second for face detection, and then each image frame is scaled. Each image frame is scaled to a standard image frame of 224*224r using a bilinear/bicubic sampling method.

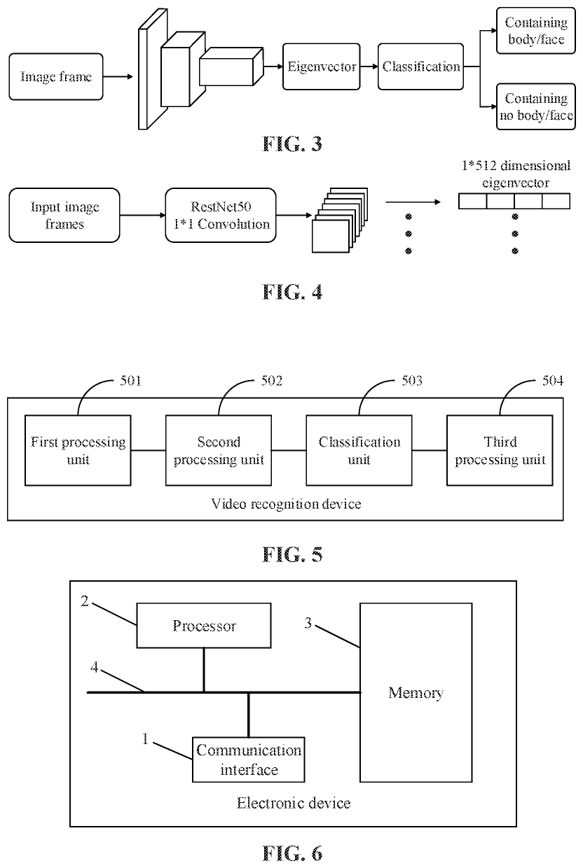

Thirdly, face recognition adopts the MTCNN network, which is trained through a large human body and face dataset (such as the Winderface dataset), and has the ability to recognize faces. The detection process is shown in FIG. 3. The features of each image frame are extracted by the network to obtain the eigenvector, and the eigenvector is compressed at the output layer to obtain a binary classification result, indicating that the image frame includes the face and does not include the face.

Fourthly, the video image not containing the face is discarded, and the clips containing the faces are spliced in chronological order to obtain a t₁ frame as the input of the video preprocessing stage. It is to be noted that, if all image frames in the video are detected as not containing the faces, the video is directly returned with no action, that is, the return is empty, and the next video preprocessing stage is not performed.

2) Video preprocessing.

In the video preprocessing stage, the video is normalized, and the eigenvector of the spatial feature of the image frame is extracted, and the obtained eigenvector of the normalized video is used as the input of a time series classification model.

This step mainly includes three parts: video frame extraction, random scaling and cropping by frame, and eigenvector embedding.

Video frame extraction is that: the t₁ frame of video obtained in the human body/face detection stage is sampled, and the sampling frequency is t₁/16, so that 16 image frames containing the faces and/or human bodies are obtained.

Random scaling and cropping by frame is that: the short side of the 16 image frames is randomly scaled to any value of (256, 320) using bilinear/bicubic sampling, and the long side adopts the same scaling ratio, that is, the long side is scaled to a corresponding value of (256*r, 320*r). After scaling, cropping is performed through the crop box of the set size (256×256).

Eigenvector embedding is that: firstly, the spatial features of the image are extracted by ResNet50 pre-trained on imagenet, then the channel features (feature maps) are compressed to 256 using 1*1 convolution, and finally eigenvectoring is performed on each feature map to obtain 1*512-dimensional eigenvector. FIG. 4 shows a schematic diagram of eigenvector embedding, and finally 256 1*512-dimensional eigenvectors corresponding to each image frame are obtained. These 1*512-dimensional eigenvectors correspond to the first eigenvectors in various embodiments, and are used as the input of the time series behavior classification stage.

3) Time series behavior classification.

In the time series behavior classification stage, the image frame vector of the preprocessed video is taken as the input, the time series features between the image frames are extracted, and behavior type classification is performed.

Firstly, the Kinetics700 dataset is preprocessed, the annotation of the behavior type of the data taking the non-commodity as the subject remains unchanged, and the annotation of the behavior type taking the commodity as the subject removes the specific commodity name, and only retains the action verb as the annotation of the data.

Secondly, the Transformer model is trained using the processed Kinects700 dataset to extract the time series features and perform behavior type recognition. The video preprocessing method in the dataset is the same as the video preprocessing in the video preprocessing step, and the multi-class cross entropy loss is used as a training loss function.

The 256 1*512 eigenvectors corresponding to each image frame obtained by the video preprocessing in the video preprocessing step are used as the input, the time series features are extracted using the trained Transformer model, and the obtained time series eigenvector (that is, the second eigenvector in each embodiment) is processed by the full connected layer to output a 1*700-dimensional vector (that is, the third eigenvector in each embodiment). The classification probability of different behavior types is obtained by softmax. The behavior type corresponding to the maximum probability is taken as the output of the time series behavior classification stage.

Herein, for a dataset with the number, such as the Kinetics700 dataset, some numbers are annotated as the behavior type with the commodity as the subject during annotation. In this way, the time series features are extracted using the trained Transformer model, the corresponding number of the behavior type in the dataset may be determined based on the model output result, and whether the behavior type takes the commodity as the subject may be determined according to the corresponding annotation information.

Here, the Transformer model not only needs to extract the spatial features between the 256 eigenvectors corresponding to each image frame in the 16 image frames, but also the time series features between the 16 image frames. In the application embodiment, separation of time and space may be realized by respectively extracting through two hidden layers. In this way, the parameters of the model are reduced, and the feature extraction effect of the model is better.

4) Commodity Detection.

The purpose of the commodity detection stage is to obtain the category name of the commodity type to prepare for the multi-strategy behavior recognition stage. In the commodity detection stage, commodity detection is performed on 16 image frames obtained by random scaling. The commodity category detection is performed on the image frames one by one using a detection network based on Yolov5, and the commodity type is returned. Finally, the commodity type recognition results of the 16 image frames are weighted to determine the commodity type of the video as the final output result of the commodity detection stage.

5) Multi-Strategy Behavior Recognition.

The multi-strategy behavior recognition stage outputs the video recognition detection result. This stage uses the category name of the commodity type obtained in the commodity detection stage and the behavior type classification result in the time series behavior classification stage, and executes different output strategies according to the behavior types.

If the behavior type detection result takes the non-commodity as the subject, the behavior type classification result is directly returned as the video recognition result, and the process ends.

If the result of the behavior type detection takes the commodity as the subject, the behavior type classification result is used as the verb, and the commodity type classification result in the commodity detection stage is used as the noun for output, that is, the form of verb and noun is returned as the result of video interaction recognition, and the process ends.

In the application embodiment, for video recognition in the e-commerce scenario, the video clips are segmented based on face and/or human body recognition, and the video clips irrelevant to video recognition are removed. Frame extraction is performed on the processed video to extract the spatial features. The time series features are extracted using the set Transformer model, and in combination with the commodity type recognition result, the corresponding video recognition result is returned. The following technical means are at least adopted to achieve the corresponding effect.

1) The video clips are extracted using face/body detection as the input of the behavior classification network, some video clips which are irrelevant to the interactive behaviors between people and the commodities may be filtered, and the accuracy of subsequent behavior classification network recognition is improved.

2) By combining the commodity detection strategy (commodity type recognition) with the behavior recognition strategy (behavior type recognition), the behavior type detection and commodity type detection are separated, and the corresponding annotated sample training model are combined according to the set strategy after detection. In this way, the richness of the video recognition types in the e-commerce scenario may be improved without relying on a large number of annotated samples.

3) The spatial features and time series features are combined, the spatial features are extracted through the convolutional network and image frame eigenvector embedding is performed, and then the time series features are extracted using the Transformer model, so that the separation of time and space may be achieved. In this way, the embedded eigenvector is obtained without splitting the spatial features of the image, thereby improving the accuracy of behavior recognition detection of the network.

In order to implement the method in the embodiments of the present disclosure, the embodiments of the present disclosure further provide a video recognition apparatus, as shown in FIG. 5, which includes: a first processing unit 501, a second processing unit 502, a classification unit 503, and a third processing unit 504.

The first processing unit 501 is configured to determine n first eigenvectors corresponding to each of m first image frames of a first video. The first eigenvector represents a spatial eigenvector of the corresponding first image frame. The image content of the first image frame may include a first object and a second object.

The second processing unit 502 is configured to extract a second eigenvector from the first eigenvectors corresponding to the m first image frames, and process the second eigenvector through a fully connected layer to obtain a third eigenvector. The second eigenvector represents a time sequence eigenvector corresponding to the m first image frames.

The classification unit 503 is configured to determine a first behavior type between the first object and the second object corresponding to the first video based on the third eigenvector. Each element in the third eigenvector correspondingly represents the probability of a behavior type.

The third processing unit 504 is configured to determine, in a case where the first behavior type is a set behavior type, a video recognition result of the first video based on the first behavior type and the type of the second object.

Herein, m and n are both positive integers.

Herein, in an embodiment, the first processing unit 501 is configured to:

input each of the m first image frames into a first feature extraction model to obtain a first feature map of each first image frame output by the first feature extraction model:

obtain N second feature maps corresponding to the first feature map of each first image frame through a convolution kernel of the set size, and

perform feature extraction on each of the n second feature maps corresponding to each first feature map to obtain n first eigenvectors corresponding to each first image frame.

In an embodiment, the first processing unit 501 is configured to:

scale each of the m first image frames of the first video according to a set ratio, and crop through a crop box of the set size to obtain m processed first image frames; and

input each of the processed m first image frames into the first feature extraction model.

In an embodiment, the second processing unit 502 is configured to:

input the first eigenvectors corresponding to the m first image frames into a second feature extraction model to obtain the second eigenvector output by the second feature extraction model. The second feature extraction model is configured to extract time sequence feature from the input first eigenvectors to obtain the corresponding second eigenvector.

In an embodiment, the second feature extraction model includes the at least two hidden layer combinations connected in series. Each hidden layer combination includes the first hidden layer and the second hidden layer connected in series. The first hidden layer is configured to extract the spatial features of each first image frame based on the n eigenvectors corresponding to each input first image frame. The second hidden layer is configured to output the time sequence features among the m first image frames based on the spatial features of respective input first image frames.

In an embodiment, the apparatus further includes: a training unit.

The training unit is configured to delete, before the first eigenvectors corresponding to the m first image frames are input into the second feature extraction model, and in a case where the behavior type of a sample is the set behavior type, the type of the second object in a corresponding annotation to obtain a processed sample: and train the second feature extraction model based on the processed sample.

In an embodiment, the apparatus further includes: a recognition unit.

The recognition unit is configured to input, before the n first eigenvectors corresponding to each of the m first image frames of the first video are determined, multiple second image frames of the second video into a recognition model to obtain an image recognition result output by the recognition model; and splice at least two second image frames whose corresponding image recognition results meet a set splicing condition to obtain the first video. Herein, the recognition model is configured to recognize the first object in the input second image frame, and output the corresponding image recognition result. The image recognition result represents the confidence that the first object is contained in the corresponding second image frame.

In an embodiment, the first object represents a set part of a person. The second object represents an item.

In an embodiment, the apparatus further includes: a fourth processing unit.

The fourth processing unit is configured to determine, in a case where the first behavior type is not the set behavior type, the video recognition result of the first video based on the first behavior type.

In practical application, the first processing unit 501, the second processing unit 502, the classification unit 503, the third processing unit 504, the training unit, the recognition unit, and the fourth processing unit may be implemented based on a processor in the video recognition apparatus, such as a Central Processing Unit (CPU), a Digital Signal Processor (DSP), a Microcontroller Unit (MCU) or a Field-Programmable Gate Array (FPGA).

It is to be noted that: when the video recognition apparatus provided in the above embodiment performs video recognition, only the division of the above program modules is used as an example for illustration. In practical application, the above processing may be allocated by different program modules according to needs. That is, the internal structure of the apparatus is classified into different program modules to complete all or part of the processing described above. In addition, the video recognition apparatus and the video recognition method embodiments provided by the above embodiments belong to the same concept, and the specific implementation process thereof is detailed in the method embodiments, which may not be repeated here.

Based on the hardware implementation of the above program modules, in order to implement the video recognition method provided by the embodiments of the present disclosure, the embodiments of the present disclosure further provide an electronic device. FIG. 6 is a schematic structural diagram of hardware compositions of an electronic device according to an embodiment of the present disclosure. As shown in FIG. 6, the electronic device includes: a communication interface 1, and a processor 2.

The communication interface 1 may exchange information with other devices such as a network device.

The processor 2 is connected with the communication interface 1 to realize information interaction with other devices, and is configured to execute the method provided by one or more of the above technical solutions when running a computer program. The computer program is stored on a memory 3.

Of course, in practical application, various components of the terminal device are coupled together through a bus system 4. It is to be understood that the bus system 4 is configured to implement connection and communication between these components. In addition to a data bus, the bus system 4 further includes a power bus, a control bus, and a status signal bus. However, for clarity of description, various buses are marked as the bus system 4 in FIG. 6.

The memory 3 in the embodiment of the present disclosure is configured to store various types of data to support the operation of the electronic device. Examples of the data include: any computer program configured to operate on the electronic device.

It should be understood that the memory 3 may be a volatile memory or a non-volatile memory, or may include both a volatile memory and a non-volatile memory. Herein, the non-volatile memory may be a Read Only Memory (ROM), a Programmable Read-Only Memory (PROM), an Erasable Programmable Read-Only Memory (EPROM), an Electrically Erasable Programmable Read-Only Memory (EEPROM), a Ferromagnetic Random Access Memory (FRAM), a Flash Memory, a magnetic surface memory, an optical disk or a Compact Disc Read-Only Memory (CD-ROM); and the magnetic surface memory may be a magnetic disk memory or a magnetic tape memory. The volatile memory may be a Random Access Memory (RAM) that acts as an external cache. By way of example and not limitation, many forms of RAM are available, such as a Static Random Access Memory (SRAM), a Synchronous Static Random Access Memory (SSRAM), a Dynamic Random Access Memory (DRAM), a Synchronous Dynamic Random Access Memory (SDRAM), a Double Data Rate Synchronous Dynamic Random Access Memory (DDRSDRAM), an Enhanced Synchronous Dynamic Random Access Memory (ESDRAM), a SyncLink Dynamic Random Access Memory (SLDRAM), and a Direct Rambus Random Access Memory (DRRAM). The memory 2 described in the embodiment of the present disclosure is intended to include, but is not limited to, these and any other suitable types of memones.

The method disclosed in the above embodiment of the present disclosure may be applied to the processor 2, or may be implemented by the processor 2. The processor 2 may be an integrated circuit chip with signal processing capability. During implementation, the steps of the above method may be completed by hardware integrated logic circuits in the processor 2 or instructions in the form of software. The above processor 2 may be a general-purpose processor, a DSP, or other programmable logic devices, discrete gate or transistor logic devices, discrete hardware components, or the like. The processor 2 may implement or perform various methods, steps, and logical block diagrams disclosed in the embodiments of the present disclosure. The general-purpose processor may be a microprocessor, or any conventional processor. Steps of the methods disclosed with reference to the embodiments of the present disclosure may be directly performed and accomplished by a hardware decoding processor, or may be performed and accomplished by a combination of hardware and software modules in the decoding processor. A software module may be located in a storage medium. The storage medium is located in the memory 3, and the processor 2 reads information in the memory 3 and completes the steps of the above-mentioned method in combination with hardware thereof.

When the processor 2 executes the program, the corresponding process in each method of the embodiments of the present disclosure is implemented, which may not be repeated here for brevity.

According to the video recognition method and apparatus, the electronic device, and the storage medium provided by the embodiments of the present disclosure, n first eigenvectors corresponding to each of m first image frames of the first video are determined. The first eigenvector represents the spatial eigenvector of the corresponding first image frame. The image content of the first image frame includes the first object and the second object. The second eigenvector is extracted from the first eigenvectors corresponding to the m first image frames, and the second eigenvector is processed through the fully connected layer to obtain the third eigenvector. The second eigenvector represents a time sequence eigenvector corresponding to the m first image frames. The first behavior type between the first object and the second object corresponding to the first video is determined based on the third eigenvector. Each element in the third eigenvector correspondingly represents the probability of the behavior type. In a case where the first behavior type is the set behavior type, the video recognition result of the first video is determined based on the first behavior type and the type of the second object. Herein, m and n are both positive integers. In the above solution, the video recognition result is determined by respectively detecting the behavior type and object type of the video. In this way, the sample does not need to be annotated through a combination of the behavior type and the object type, which reduces the number of samples required for video recognition and reduces the cost of acquiring a video recognition model.

In an exemplary embodiment, the embodiments of the present disclosure further provide a storage medium, that is, a computer storage medium, specifically a computer-readable storage medium, for example, including a memory 3 storing a computer program, and the above computer program may be executed by the processor 2, to complete the steps of the above-mentioned method. The computer-readable storage medium may be a memory such as a FRAM, a ROM, a PROM, an EPROM, an EEPROM, a Flash Memory, a magnetic surface memory, a compact disc, or a CD-ROM.

In some embodiments provided by the present disclosure, it is to be understood that, the disclosed apparatus, the electronic device and the method may be implemented in other ways. The device embodiment described above is only schematic, and for example, division of the units is only logic function division, and other division manners may be adopted during practical implementation. For example, multiple units or components may be combined or integrated into another system, or some characteristics may be neglected or not executed. In addition, coupling or direct coupling or communication connection between each displayed or discussed component may be indirect coupling or communication connection, implemented through some interfaces, of the device or the units, and may be electrical and mechanical or adopt other forms.

The above units described as separate components may be or may be not physically separated or not, and the components illustrated as units may be or may be not physical units or not, i.e., they may be located at the same one place or distributed in multiple network elements. Some of or all the units may be selected according to actual demands to implement the purpose of the embodiments of the present disclosure.

In addition, the functional units in the embodiments of the present disclosure may be integrated in into a processing unit, or each of the units may be act as a unit separately, or two or more may be integrated into one unit. The above integrated unit may be implemented as in the form of hardware or in the form of hardware and software functional units.

It is to be understood by those of ordinary skill in the art that all or some of or all the steps of the above method embodiments may be implemented by program instruction related hardware under an instruction from a program. The above-mentioned program may be stored in a computer-readable storage medium. The program, when executed, executes the steps including the above method embodiments. The above-mentioned storage medium includes various media capable of storing program codes such as a mobile hard disk drive, a ROM, a RAM, a magnetic disk, or a compact disc.

Or, when being implemented in form of software function module and sold or used as an independent product, the above integrated unit of the present disclosure may also be stored in a computer-readable storage medium. Based on such an understanding, the technical solutions of the embodiments of the present disclosure substantially or parts making contributions to the conventional art may be embodied in form of software product, and the computer software product is stored in a storage medium, including multiple instructions configured to enable a computing device (which may be a personal computer, a server, a network device or the like) to execute all or part of the method in each embodiment of the present disclosure. The above-mentioned storage medium includes: various media capable of storing program codes such as a mobile hard disk, a ROM, a RAM, a magnetic disk or a compact disc.

It is to be understood that, in the embodiments of the present disclosure, related data of user information, such as face information of the image content are involved. When the embodiments of the present disclosure are applied to specific products or technologies, the user permission or consent is required, and the collection, use and processing of related data need to comply with relevant laws, regulations and standards of relevant countries and regions.

It is to be noted that the technical solutions described in the embodiments of the present disclosure may be arbitrarily combined without conflict. Unless otherwise specified and defined, the term “connection” may be electric connection or communication inside two elements or direct connection or indirect connection through an intermediate. Those of ordinary skill in the art may understand the meanings of the above terms in the embodiments of the present disclosure in specific situations.

In addition, the terms “first”, “second” and the like in the examples of the present disclosure are used to distinguish similar objects, and are not necessarily used to describe a specific order or sequence. It is to be understood that the objects distinguished by “first\second\third” may be interchangeable under appropriate circumstances, so that the embodiments of the present disclosure described herein may be implemented in an order other than those illustrated or described herein.

The term “and/or” herein describes only an association relationship for describing associated objects and represents that three relationships may exist. For example, A and/or B may represent the following three cases: Only A exists, both A and B exist, and only B exists. In addition, the term “at least one” herein represents any one of multiple or any combination of at least two of the multiple, for example, including at least one of A, B and C, which may represent including any one or more elements selected from a set consisting of A, B and C.

The above is only the specific implementation mode of the present disclosure and not intended to limit the scope of protection of the present disclosure. Any variations or replacements apparent to those skilled in the art within the technical scope disclosed by the application shall fall within the scope of protection of the present disclosure. Therefore, the scope of protection of the present disclosure shall be subject to the scope of protection of the claims.

The specific technical features in the various embodiments described in the specific implementation mode may be combined in various ways without contradiction. For example, different specific technical features may be combined to form different implementation modes. In order to avoid unnecessary repetition, various possible combinations of various specific technical features in the present disclosure may not be described separately.

1. A video recognition method, comprising:
determining n first eigenvectors corresponding to each of m first image frames of a first video, the first eigenvector representing a spatial eigenvector of a corresponding first image frame, and image content of the first image frame comprising a first object and a second object;
extracting a second eigenvector from the first eigenvectors corresponding to the m first image frames, and processing the second eigenvector through a fully connected layer to obtain a third eigenvector, the second eigenvector representing a time sequence eigenvector corresponding to the m first image frames;
determining a first behavior type between the first object and the second object corresponding to the first video based on the third eigenvector, each element in the third eigenvector correspondingly representing a probability of a behavior type; and
in a case where the first behavior type is a set behavior type, determining a video recognition result of the first video based on the first behavior type and a type of the second object; wherein
m and n are both positive integers.

2. The method of claim 1, wherein the determining n first eigenvectors corresponding to each of m first image frames of a first video comprises:
inputting each of the m first image frames into a first feature extraction model to obtain a first feature map of the first image frame output by the first feature extraction model;
obtaining n second feature maps corresponding to the first feature map of each first image frame through a convolution kernel of the set size; and
performing feature extraction on each of the n second feature maps corresponding to each first feature map to obtain the n first eigenvectors corresponding to each first image frame.

3. The method of claim 2, wherein the inputting each of the m first image frames into a first feature extraction model comprises:
scaling each of the m first image frames of the first video according to a set ratio, and cropping the scaled first image frame through a crop box of a set size, to obtain m processed first image frames; and
inputting each of the processed m first image frames into the first feature extraction model.

4. The method of claim 1, wherein the extracting a second eigenvector from the first eigenvectors corresponding to the m first image frames comprises:
inputting the first eigenvectors corresponding to the m first image frames into a second feature extraction model to obtain the second eigenvector output by the second feature extraction model, the second feature extraction model being configured to extract time sequence feature from the input first eigenvectors to obtain the corresponding second eigenvector.

5. The method of claim 4, wherein the second feature extraction model comprises at least two hidden layer combinations connected in series, each hidden layer combination comprising a first hidden laver and a second hidden layer connected in series, the first hidden layer being configured to extract spatial features of each first image frame based on input eigenvectors, and the second hidden layer being configured to output time sequence features among the m first image frames based on the spatial features of respective input first image frames.

6. The method of claim 4, wherein before inputting the first eigenvectors corresponding to the m first image frames into the second feature extraction model, the method further comprises:
in a case where the behavior type of a sample is a set behavior type, deleting a type of the second object in a corresponding annotation to obtain a processed sample; and
training the second feature extraction model based on the processed sample.

7. The method of claim 1, wherein before determining the n first eigenvectors corresponding to each of the m first image frames of the first video, the method further comprises:
inputting multiple second image frames of the second video into a recognition model to obtain an image recognition result output by the recognition model; and
splicing at least two second image frames whose corresponding image recognition results meet a set splicing condition to obtain the first video; wherein
the recognition model is configured to recognize the first object in an input second image frame, and output a corresponding image recognition result; and the image recognition result represents a confidence that the first object is contained in the corresponding second image frame.

8. The method of claim 1, wherein the first object represents a set part of a person; and the second object represents an item.

9. The method of claim 1, further comprising:
in a case where the first behavior type is not the set behavior type, determining a video recognition result of the first video based on the first behavior type.

10. A video recognition apparatus, comprising:
a memory for storing executable instructions; and
a processor,
wherein the processor is configured to execute the instructions to perform operations of:
determining n first eigenvectors corresponding to each of m first image frames of a first video, the first eigenvector representing a spatial eigenvector of a corresponding first image frame, and image content of the first image frame comprising a first object and a second object;
extracting a second eigenvector from the first eigenvectors corresponding to the m first image frames, and process the second eigenvector through a fully connected layer to obtain a third eigenvector, the second eigenvector representing a time sequence eigenvector corresponding to the m first image frames;
determining a first behavior type between the first object and the second object corresponding to the first video based on the third eigenvector, each element in the third eigenvector correspondingly representing a probability of a behavior type; and
determining, in a case where the first behavior type is a set behavior type, a video recognition result of the first video based on the first behavior type and a type of the second object; wherein
m and n are both positive integers.

11. The video recognition apparatus of claim 10, wherein the determining n first eigenvectors corresponding to each of m first image frames of a first video comprises:
inputting each of the m first image frames into a first feature extraction model to obtain a first feature map of the first image frame output by the first feature extraction model;
obtaining n second feature maps corresponding to the first feature map of each first image frame through a convolution kernel of the set size; and
performing feature extraction on each of the n second feature maps corresponding to each first feature map to obtain the n first eigenvectors corresponding to each first image frame.

12. The video recognition apparatus of claim 11, wherein the inputting each of the m first image frames into a first feature extraction model comprises:
scaling each of the m first image frames of the first video according to a set ratio, and cropping the scaled first image frame through a crop box of a set size, to obtain m processed first image frames; and
inputting each of the processed m first image frames into the first feature extraction model.

13. The video recognition apparatus of claim 10, wherein the extracting a second eigenvector from the first eigenvectors corresponding to the m first image frames comprises:
inputting the first eigenvectors corresponding to the m first image frames into a second feature extraction model to obtain the second eigenvector output by the second feature extraction model, the second feature extraction model being configured to extract time sequence feature from the input first eigenvectors to obtain the corresponding second eigenvector.

14. The video recognition apparatus of claim 13, wherein the second feature extraction model comprises at least two hidden layer combinations connected in series, each hidden layer combination comprising a first hidden layer and a second hidden layer connected in series, the first hidden layer being configured to extract spatial features of each first image frame based on input eigenvectors, and the second hidden layer being configured to output time sequence features among the m first image frames based on the spatial features of respective input first image frames.

15. The video recognition apparatus of claim 13, wherein the processor is further configured to execute the instructions to perform operations of:
before inputting the first eigenvectors corresponding to the m first image frames into the second feature extraction model, in a case where the behavior type of a sample is a set behavior type, deleting a type of the second object in a corresponding annotation to obtain a processed sample; and
training the second feature extraction model based on the processed sample.

16. The video recognition apparatus of claim 10, wherein the processor is further configured to execute the instructions to perform operations of:
before determining the n first eigenvectors corresponding to each of the m first image frames of the first video, inputting multiple second image frames of the second video into a recognition model to obtain an image recognition result output by the recognition model; and
splicing at least two second image frames whose corresponding image recognition results meet a set splicing condition to obtain the first video; wherein
the recognition model is configured to recognize the first object in an input second image frame, and output a corresponding image recognition result; and the image recognition result represents a confidence that the first object is contained in the corresponding second image frame.

17. The video recognition apparatus of claim 10, wherein the first object represents a set part of a person; and the second object represents an item.

18. The video recognition apparatus of claim 10, wherein the processor is further configured to execute the instructions to perform an operation of:
in a case where the first behavior type is not the set behavior type, determining a video recognition result of the first video based on the first behavior type.

19. A non-transitory storage medium having stored thereon a computer program that when executed by a processor, implements steps of a video recognition method, the method comprising:
determining n first eigenvectors corresponding to each of m first image frames of a first video, the first eigenvector representing a spatial eigenvector of a corresponding first image frame, and image content of the first image frame comprising a first object and a second object;
extracting a second eigenvector from the first eigenvectors corresponding to the m first image frames, and processing the second eigenvector through a fully connected layer to obtain a third eigenvector, the second eigenvector representing a time sequence eigenvector corresponding to the m first image frames;
determining a first behavior type between the first object and the second object corresponding to the first video based on the third eigenvector, each element in the third eigenvector correspondingly representing a probability of a behavior type; and
in a case where the first behavior type is a set behavior type, determining a video recognition result of the first video based on the first behavior type and a type of the second object; wherein
m and n are both positive integers.

20. The non-transitory storage medium of claim 19, wherein the determining n first eigenvectors corresponding to each of m first image frames of a first video comprises:
inputting each of the m first image frames into a first feature extraction model to obtain a first feature map of the first image frame output by the first feature extraction model;
obtaining n second feature maps corresponding to the first feature map of each first image frame through a convolution kernel of the set size; and
performing feature extraction on each of the n second feature maps corresponding to each first feature map to obtain the n first eigenvectors corresponding to each first image frame.
